(19) United States
(12) Patent Application Publication
(10) Pub. No.: US 2023/0241428 A1
(43) Pub. Date: Aug. 3, 2023

(54) PVDF FILTERING FACE-PIECE RESPIRATOR AND RECYCLING METHOD

(71) Applicant: Arkema France, Colombes (FR)

(72) Inventors: Anthony BONNET, Colombes (FR); Jerome CHAUVEAU, Serquigny (FR); Salima BOUTTI, Serquigny (FR)

(21) Appl. No.: 18/008,699

(22) PCT Filed: Jun. 18, 2021
(86) PCT No.: PCT/FR2021/051110

§ 371 Date: Dec. 7, 2022

(30) Foreign Application Priority Data
Jun. 19, 2020 (FR) FR2006430

(51) Int. Cl. A62B 23/02; B01D 39/16; A62B 18/08

(52) U.S. Cl. CPC A62B 23/025; A62B 18/084; B01D 39/1623; B01D 2239/10; B01D 2239/025; B01D 2239/0618; B01D 2239/0631; B01D 2239/0636; B01D 2239/0654; B01D 2239/1233; B01D 2239/1291

(57) ABSTRACT

The invention relates to a respiratory protection mask made of polyvinylidene fluoride and to a method for manufacturing said mask. The invention also relates to a method for reconditioning said mask. The invention also relates to a method for recycling this respiratory protection mask.

### FIELD OF THE INVENTION

The present invention relates to a respiratory protection mask made of polyvinylidene fluoride and to a method for manufacturing said mask. The invention also relates to a method for reconditioning said mask. The invention also relates to a method for recycling this respiratory protection mask.

### TECHNICAL BACKGROUND

Particle masks are respiratory protection devices capable of filtering particles and fine dust. These masks include personal protective equipment such as FFP masks (for “Filtering Facepiece Particles”). Their scope of protection is determined by European standard EN 149 which specifies the minimum characteristics to be required of filtering half masks used as respiratory protection devices against particles, excluding those for escape purposes. This standard defines three classes of devices, namely FFP1, FFP2 and FFP3, on the basis of three criteria: the maximum penetration of the filtering material by aerosols of mass-average diameter of 0.6 µm, the respiratory resistance and the inward leakage rate.

The FFP1 dust mask has an aerosol filtration rate of at least 80% and an inward leakage rate of no more than 22%.

The FFP2 mask has an aerosol filtration rate of at least 94% and an inward leakage rate of no more than 8%. This mask protects against pulverulent chemical substances and may also serve to protect against aerosols carrying viral particles and/or bacteria.

The FFP3 mask has an aerosol filtration rate of no less than 99% and an inward leakage percentage of no more than 2%. It protects against very fine particles of asbestos (asbestosis) or of silica (silicosis).

There are also masks for medical use (surgical masks) developed in accordance with the standard EN 14683, intended to avoid the projection towards the surroundings of droplets emitted by the person wearing the mask. These masks also protect the wearer against the projection of droplets emitted by a person facing them. On the other hand, depending on the circumstances, they do not protect against the inhalation of very small particles suspended in the air and potentially carrying viruses.

Respiratory protection masks are generally composed of fibers, or combinations of synthetic fibers, obtained from thermoplastic polymers such as: polyolefins, polyamides, polyvinyls, polyimides, polyacrylates, polymethacrylates, polyurethanes or else fluoropolymers, and in particular polyvinylidene fluoride (PVDF). The most widely used polymers to date are polyolefins, and in particular polypropylene.

Among the many types of masks known, some comprise at least one layer of nanofibers which are particularly suitable for ensuring the barrier properties required for FFP-type respiratory protection. The solution electrospinning of polymers makes it possible to obtain, under certain conditions, fibers having sufficiently small diameters for good breathability and good mechanical and electrostatic filtration efficiency of the membrane for air filtration.

Document EP 2517607 describes the advantages of masks comprising at least one layer of nanofibers, and the manufacture thereof by electrospinning. The masks have structures of the sandwich type since they comprise several superposed layers, for example a triple layer of the type: nonwoven layer - nanofibrous layer - nonwoven layer.

Document US2019/0314746 describes the obtaining of a nonwoven porous PVDF membrane by an electrospinning process, suitable for air filtration. The nanofibers are electrospun onto the surface of a drum covered with a nonwoven polypropylene (PP) substrate.

The growing use of single-use (disposable) respiratory masks is leading to a major environmental problem in terms of managing this waste and/or reusing the polymer material used for the manufacture of these masks. Used masks are potentially laden with particles and/or contaminated with pathogenic microorganisms (bacteria and/or viruses).

Some types of masks can undergo one or more cleaning and sterilization cycles without a deterioration in their filtering properties. Several methods for cleaning used masks are known: washing with a detergent at 60 or 95° C., sterilization at 121° C. for 50 minutes, irradiation with gamma or beta radiation, exposure to ethylene oxide, heating at 70° C. in a dry heat or in water, the use of hydrogen peroxide vapors.

There is a need to develop new air filtration masks which are resistant, i.e. which retain their air permeability and filtration performance qualities in accordance with the standards EN149 and EN14683, at temperatures that can reach 80-90° C., temperatures which can be reached in particular during hot machine washing or during heating under pressure in an autoclave.

However, even when the cleaning is effective and makes it possible to remove the dust particles and/or the microorganisms deposited on the mask, the mask can only undergo a limited number of cleaning cycles, after which there are the problems of the treatment of the used masks and of the desired recovery of all or some of the raw materials that were used to manufacture them.

There is therefore a need to develop a method for recycling used masks that makes it possible to prevent their accumulation and possible pollution of the environment and to recover the raw materials that were used to manufacture them.

It has now been found that a mask consisting of a single raw material, namely PVDF, has very good filtration properties, making it possible to meet the criteria required for FFP masks, according to European standard EN 149, as well as those required for surgical masks, according to the standard EN 14683. The PVDF mask according to the invention is capable of undergoing a cleaning process and is therefore reusable. In addition, used masks consisting of PVDF can feed a recycling process enabling easy reuse of the sole polymer used in their manufacture.

### SUMMARY OF THE INVENTION

The invention proposes to provide a respiratory protection mask capable of satisfying at least one of the above-mentioned needs.

According to a first aspect, a subject of the invention is a respiratory protection mask made of polyvinylidene fluoride (PVDF) and having the following structure:
an inner layer of nonwoven PVDF,
a central PVDF layer composed of a support layer of PVDF on which PVDF nanofibers are deposited by electrospinning,
an outer layer of nonwoven PVDF,
a nose bridge composed of a mixture of PVDF homopolymer and of a VDF copolymer, and
PVDF retaining straps.

According to a second aspect, the invention relates to a method for manufacturing said PVDF mask, said method comprising the following steps:
providing a first layer of nonwoven PVDF, intended to constitute the outer and inner layers;
providing a second layer of PVDF, the latter being chosen from nonwoven polymer or polymer obtained by extrusion spinning, intended to constitute the support layer of the central layer;
depositing on said support layer, via an electrospinning process, a layer of PVDF nanofibers,
inserting a nose bridge composed of a mixture of PVDF homopolymer and of a VDF copolymer, for example into a space created by folding over the nonwoven material, and
providing retaining straps and attaching them to the ends of the mask by welding.

According to a third aspect, the invention relates to a method for reconditioning said PVDF mask, said method implementing a technique chosen from:
treatment with a solution of hydrogen peroxide at a concentration of less than 8%;
treatment with UV-C with an energy of greater than or equal to1 J/cm²;
treatment with dry or wet heat at a temperature of greater than or equal to 60° C. (oven, autoclave, microwave)

The invention also relates to a method for recycling poly(vinylidene fluoride) or PVDF respiratory protection masks, said method comprising the following steps:
a) optionally, grinding the masks to result in the obtaining of flakes or chips,
b) granulating (extruding) said flakes to result in the obtaining of PVDF granules,
c) using said granules for the melt or solvent-based processing of the PVDF.

A subject of the invention is a mask having all the performance qualities of an FFP-type mask or of a surgical mask, but consisting of a single thermoplastic raw material and having the advantage of being reusable multiple times either by sterilization or by washing. The use of nonwoven PVDF for the inner layers makes it possible to avoid any phenomenon of heating and sensitization of the skin when the mask is in contact with the face.

### DESCRIPTION OF EMBODIMENTS OF THE INVENTION

The invention is now described in more detail and in a non-limiting way in the description which follows.

The invention is based on the discovery of the ability of polyvinylidene fluoride to be processed, by means of several techniques, into different fiber layers making it possible, via the assembly thereof, to manufacture FFP-type respiratory protection masks and also surgical masks, said masks on the one hand being washable, reusable and sterilizable while preserving a high level of air filtration, and on the other hand being able to be subjected to a recycling method to recover the polymer with a view to reusing it. The fluoropolymer used in the invention and generically denoted by the abbreviation PVDF is a polymer based on vinylidene difluoride.

The PVDF employed within the context of the invention is a thermoplastic polymer. The term “thermoplastic” means here a nonelastomeric polymer. An elastomeric polymer is defined as being a polymer which can be drawn, at ambient temperature, to twice its initial length and which, after releasing the stresses, rapidly resumes its initial length, to within about 10%, as indicated by the ASTM in the Special Technical Publication, No. 184.

According to a first aspect, a subject of the invention is a respiratory protection mask made of polyvinylidene fluoride and having the following structure:
an inner layer of nonwoven PVDF,
a central PVDF layer composed of a support layer of PVDF and an electrospun layer of PVDF nanofibers,
an outer layer of nonwoven PVDF,
a nose bridge composed of a mixture of PVDF homopolymer and of a VDF copolymer, and
PVDF retaining straps.

According to various embodiments, said mask comprises the following features, combined where appropriate.

According to one embodiment, the respiratory protection mask consists of a body and of retaining straps, said body being composed of several layers, including a layer of filtering material, said retaining straps being fixed to the body of the mask without addition of material, preferably by welding.

According to one embodiment, the inner layer of the mask is a nonwoven PVDF and has a grammage of between 20 and 100 g/m², having a permeability of between 500 and 1500 l/m²/s measured at a pressure of 100 Pa. This PVDF can be a PVDF homopolymer with a viscosity of 3200 Pa.s at 230° C. and 100 s⁻¹.

The central layer of the mask is composed of a nonwoven support of PVDF on which PVDF nanofibers are deposited by electrospinning.

According to one embodiment, the support layer is a nonwoven PVDF, with a grammage of between 20 and 100 g/m² and having a permeability of between 500 and 2500 l/m²/s measured at a pressure of 100 Pa. This PVDF can be a PVDF homopolymer with a viscosity of 3200 Pa.s at 230° C. and 100 s⁻¹.

According to another embodiment, the support layer is a PVDF produced by extrusion spinning. This PVDF can be a PVDF homopolymer having a melt flow rate (MFR) of 34 g/10 min at 230° C. under 2.16 kg.

On this support is deposited, by an electrospinning process, a layer of PVDF nanofibers which comprises, and preferably consists of:
i. a PVDF homopolymer;
ii. a mixture of two PVDF homopolymers having different viscosities, or different molar masses, or different architectures, for example different degrees of branching;
iii. a copolymer comprising vinylidene difluoride (VDF) units and one or more types of units of comonomers compatible with vinylidene difluoride (referred to hereinafter as “VDF copolymer”);
iv. a mixture of a PVDF homopolymer and of a VDF copolymer;
v. a mixture of two VDF copolymers.

The comonomers compatible with vinylidene difluoride can be halogenated (fluorinated, chlorinated or brominated) or non-halogenated. The term “compatible comonomer” is understood here to mean the ability of said comonomer to copolymerize with VDF and thus form a copolymer.

Examples of appropriate fluoro comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of the general formula Rf-O-CF-CF₂, Rf being an alkyl group, preferably a C₁ to C₄ alkyl group (preferred examples being perfluoropropyl vinyl ether and perfluoromethyl vinyl ether). The fluoromonomer can comprise a chlorine or bromine atom. It can in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. Chlorotrifluoropropene is preferably 1-chloro-3,3,3-trifluoropropene or 2-chloro-3,3,3-trifluoropropene.

The VDF copolymer can also comprise non-halogenated monomers, such as ethylene, and/or acrylic or methacrylic comonomers.

When the layer of nanofibers is composed of a mixture of two constituents from among those mentioned above (ii., iv. and v.), the proportion by mass between the constituents ranges from 1:99 to 99:1.

All the viscosities are measured at 232° C., at a shear rate of 100 s⁻¹, using a capillary rheometer or a parallel-plate rheometer, according to the standard ASTM D3835.

The PVDF homopolymers and the VDF copolymers used in the invention can be obtained by known polymerization methods, such as solution, emulsion or suspension polymerization. According to one embodiment, they are prepared by an emulsion polymerization process in the absence of a fluorinated surfactant.

According to some embodiments, the PVDF homopolymer and the VDF copolymers are composed of biobased VDF. The term “biobased” means “derived from biomass”. This makes it possible to improve the ecological footprint of the membrane. Biobased VDF can be characterized by a content of renewable carbon, that is to say of carbon of natural origin originating from a biomaterial or from biomass, of at least 1 atom%, as determined by the content of ¹⁴C according to Standard NF EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

According to one embodiment, said PVDF nanofibers have a mean fiber diameter Dv50 of between 30 and 500 nm, preferably from 30 to 300 nm.

According to one embodiment, said electrospun PVDF layer has a grammage of between 0.03 g/m² and 3 g/m².

The Dv50 is the volume-median diameter, which corresponds to the value of the particle size which divides the population of particles examined exactly into two. The Dv50 is measured according to the standard ISO 9276 - parts 1 to 6.

The mean thickness of this layer of PVDF nanofibers is from 0.1 µm to 100 µm. The diameter of the fibers, their thickness and their distribution can be estimated by scanning electron microscopy (SEM).

The solvent used in the electrospinning to dissolve the PVDF is chosen from cyclopentanone, N,N-dimethylacetamide, N,N-dimethylformamide, dimethyl sulfoxide, acetone, ethyl methyl ketone, tetrahydrofuran, γ-butyrolactone, hexafluoroisopropanol, or mixtures thereof in all proportions.

According to one embodiment, the layer of PVDF deposited by electrospinning is electrically charged by a corona treatment in order to improve its filtration properties and to obtain air permeability and filtration performance qualities in accordance with the standards EN149 and EN14683, and a pressure drop of much less than 70 Pa.s for an air inspiration flow rate of 95 l/min.

The mask also comprises an outer layer of nonwoven PVDF, with a grammage of between 10 and 60 g/m².

The grammage can be estimated by simply weighing a given area, for example 200 mm × 250 mm, preferably after baking to ensure the absence of residual solvent. This PVDF can be a PVDF homopolymer with a viscosity of 3200 Pa.s at 230° C. and 100 s⁻¹ and having a permeability of between 500 and 2500 l/m²/s measured at a pressure of 100 Pa.

The metal filament present in most respiratory protection masks, which allows it to be adjusted on the nose, is replaced, in the mask according to the invention, by a PVDF bridge, said bridge containing a mixture formed from PVDF homopolymer and a copolymer of vinylidene fluoride and of a comonomer chosen from hexafluoropropylene (HFP), tetrafluoroethylene (TFE) and vinylidene trifluoride (TrFE), the proportion by mass of the homopolymer relative to that of the copolymer ranging from 10:90 to 90:10, preferentially from 25:75 to 75:25.

According to one embodiment, said bridge is manufactured from a mixture of PVDF homopolymer and a P(VDF-HFP) copolymer, the content by mass of HFP in the copolymer being greater than 20% and the ratio by mass between the two constituents ranging from 30:70 to 70:30, preferably from 40:60 to 60:40.

According to one embodiment, said bridge is manufactured from a mixture of 50% by mass of PVDF homopolymer and 50% of a P(VDF-HFP) copolymer with a viscosity of 3300 Pa.s at 230° C. and 100 s⁻¹, exhibiting a co-continuous biphasic morphology (percolation of the two phases, the PVDF matrix and the copolymer) and a yield point elongation of less than 0.5%.

The PVDF bridge exhibits a permanent deformation during the forming pressure. According to one embodiment, it is inserted into a space created by folding over the nonwoven material.

According to one embodiment, the PVDF retaining straps are adjustable loops produced by injection molding or 3D printing.

According to one embodiment, the PVDF retaining straps are elastic bands based on PVDF textile (nonwoven or wrapped filaments). This PVDF can be a PVDF homopolymer with a viscosity of 3200 Pa.s at 230° C. and 100 s⁻¹, capable of winding around itself to obtain the desired elastic effect.

According to a second aspect, the invention relates to a method for manufacturing said PVDF mask, said method comprising the following steps:
providing a first layer of nonwoven PVDF, intended to constitute the outer and inner layers;
providing a second layer of PVDF, the latter being chosen from nonwoven polymer or polymer obtained by extrusion spinning, intended to constitute the support layer of the central layer;
depositing on said support layer, via an electrospinning process, a layer of PVDF nanofibers;
inserting a nose bridge composed of a mixture of PVDF homopolymer and of a VDF copolymer into a space created by folding over the nonwoven material,
welding, for example by ultrasound, PVDF retaining straps onto the body of the mask, at the ends.

The use of a single type of particularly resistant material (polyvinylidene fluoride) makes the mask according to the invention capable of undergoing easy recycling for subsequent use. It thus contributes to reducing the environmental impact of this article, while being particularly effective in protecting its wearer.

The mask according to the invention has the advantages of being sterilizable by UV-C or UV-B irradiation without there being any degradation of the components of the mask, since PVDF is extremely resistant to this type of radiation, in contrast to other materials of polypropylene or poly(ethylene terephthalate) type, which undergo degradation during sterilization cycles under UV radiation and particularly under a UV-C (254 nm) lamp.

In addition, the mask according to the invention can be decontaminated by heating to 70° C. in a dry heat or in water.

According to a third aspect, the invention relates to a method for reconditioning said PVDF mask, said method implementing a technique chosen from:
treatment with a solution of hydrogen peroxide at a concentration of less than 8%;
treatment with UV-C with an energy of greater than or equal to1 J/cm²;
treatment with dry or wet heat at a temperature of greater than or equal to 60° C. (oven, autoclave or microwave)

The invention also relates to a method for recycling used poly(vinylidene fluoride) or PVDF respiratory protection masks, said method comprising the following steps:
a) optionally, grinding the masks to result in the obtaining of flakes,
b) granulating said flakes to result in the obtaining of PVDF granules,
c) using said granules for the melt or solvent-based processing of the PVDF.

According to various embodiments, said method comprises the following features, combined where appropriate.

The term “used mask” employed here includes masks that have served their purpose (worn out), and also unused masks that have expired because they have exceeded the warranty period provided by the manufacturer, and even waste material recovered during the manufacture of the masks, which can represent 15% to 16% of the total material used.

The grinding step is optional if the nose bridge is made of PVDF.

If a metal nose bridge is present in the mask to be recycled, grinding is necessary in order to remove these metal parts. The used masks are passed through a knife mill to process them into fibers of a few millimeters. A screen makes it possible to calibrate the fiber pulp according to the desired length. The metal parts are removed by means of a magnet.

The grinding of the used masks is carried out at a temperature which is at least 30° C. below the melting temperature Tm. For PVDF, the temperature generated by shearing must not exceed 140° C.

According to one embodiment, the granulation step is carried out continuously.

The mask according to the invention can be introduced into an extruder, either having been ground or shredded beforehand, or directly, at a temperature of between 220 and 250° C. in a BUSS-or twin-screw type extruder, and then granulated. The product thus granulated can again be melt processed into PVDF. Indeed, the very great stability of PVDF makes it possible to recycle it in a molten medium without this generating any variation in its viscosity or its mechanical properties.

According to one embodiment, the granulation is carried out in the molten state by extrusion through a die with circular holes, followed by chopping of the cooled strands and drying in order to produce granules of 1 to 5 millimeters in diameter.

According to another embodiment, the melt granulation takes place in a BUSS-type co-kneader with underwater chopping and production of lenticular granules.

The PVDF obtained by the recycling method according to the invention can subsequently be processed via a molten or solvent-based route for the manufacture of any type of article, in particular in the form of a film, fiber, cable or molded part.

### EXAMPLES

The following examples illustrate the invention without limiting it.

### Example 1: Production of Nonwoven PVDF by Spun-Bonding

A VF2 homopolymer with a melt flow rate (MFR) of 32 g/10 min at 230° C. under 2.16 kg is employed in nonwoven extrusion by spun-bonding (spunbond) and thermal consolidation by calendering. Several grammages (g/m²) are produced with a width of 250 mm and a length of 250 m. Three different masses per unit area are thus produced using the conditions shown in table 1.

TABLE 1

| | Spunbond 1 | Spunbond 2 | Spunbond 3 |
|---|---|---|---|
| T (°C) extrusion inlet/outlet | 205/230 | 205/230 | 205/230 |
| T (°C) transfer piping | 235 | 235 | 235 |
| T (°C) spinning pump | 235 | 235 | 235 |
| Spinning pump output (kg/h) | 8.8 | 8.8 | 8.8 |
| T (°C) spinning pack product | 234 | 234 | 234 |
| Spinning pack pressure (MPa) | 7.4 | 7.4 | 7.4 |
| Speed (m/s) and T (°C) of cooling | 0.65 18 | 0.65 18 | 0.65 18 |
| Spinning/web formation distance (mm) | Spinning: 1070 Web formation: 600 | Spinning: 1070 Web formation: 600 | Spinning: 1070 Web formation: 600 |
| Conveyor speed (m/min) | 11.7 | 14.6 | 29.2 |
| Mass per unit area (g/m²) | 41 | 30.6 | 21.7 |
| Permeability 1/m²/s (200 Pa) | 4300 | 6350 | 7850 |

### Example 2: Production of Nonwoven PVDF by Melt Blowing

A VF2 homopolymer with an MFR of greater than 1200 g/10 min at 230° C. under 2.16 kg is employed in nonwoven extrusion by melt blowing (“meltblown”). Two grammages (gsm) are thus produced with a width of 550 mm using the conditions indicated in table 2.

TABLE 2

| | Meltblown 1 | Meltblown 2 |
|---|---|---|
| T (°C) extrusion inlet/outlet | 190/240 | 190/240 |
| T (°C) transfer piping | 240 | 240 |
| T (°C) and air pressure (MPa) | 240 | 240 |
| | 0.07 | 0.083 |
| Die/conveyor distance (mm) | 130 | 130 |
| Conveyor speed (m/min) | 6.1 | 10.5 |
| Mass per unit area (g/m²) | 39.2 | 22.7 |
| Permeability l/m²/s (200 Pa) | 313 | 545 |

### Example 3: Production of Electrospun Fibers on 30 G/m² Spunbond Produced in Example 1

A mixture of VF2 homopolymer (Kynar®761A) and copolymer (Kynar®2801-00) is dissolved with stirring for 2 hours at 55° C. and according to the composition indicated in table 3.

TABLE 3

Electrospinning solution composition

| | |
|---|---|
| DMAC (wt%) | 62.6 |
| Acetone (wt%) | 25 |
| K761A (wt%) | 8.05 |
| K2801 (wt%) | 3.45 |
| Pluronic F127 (wt%) | 0.4 |
| Triton X-100 (wt%) | 0.5 |

This solution is then supplied to an electrospinning process on a 30 g/m² PVDF spunbond support as produced in example 1. A filtration membrane based on electrospun fibers is thus produced with a width of 250 mm using the conditions indicated in table 4.

TABLE 4

| | Electrospinning 1 |
|---|---|
| Emitter-collector distance (mm) | 150 |
| Emitter voltage (kV) | 42 |
| Collector voltage (kV) | -45 |
| Airflow in the chamber (m³/h) | 600 |
| Chamber air temperature (°C) | 25 |
| Chamber air relative humidity (%) | 25 |
| Rotational speed of electrospinning heads (rpm) | 18500 |
| Polymer solution flow rate (ml/min) | 2.5 |
| Conveyor speed (m/min) | 5 |
| Oven temperature (°C) | 45 |
| Material penetration according to EN149+A1 (%) | 6 |
| Permeability 1/m²/s (100 Pa) | 97 |

### Example 4: Nose Bridge Production

The nasal support bridge is formed of a PVDF rod 1.5 mm in diameter and 10 cm in length. This rod is obtained by mixing/extrusion at 230° C. in a single-screw extruder of a 50/50 by mass mixture of Kynar®705 homopolymer and Kynar® UltraFlex copolymer with a viscosity of 3300 Pa.s at 230° C. and 100 s⁻¹, exhibiting a biphasic morphology and a yield point elongation which is particularly low and less than 0.5%.

### Example 5: Manufacture of the Retaining Elastic Bands by Winding Nonwovens Produced in Examples 1 and 2

A) The elastic bands of the mask are produced from the 41 g/m² spunbond nonwoven produced in example 1. The required elasticity is obtained by winding several strips around themselves and amongst themselves, typically 2 strips, 1 cm wide cut from the spunbond nonwoven material 1.

B) The elastic bands of the mask are produced from the 39.2 g/m² meltblown nonwoven produced in example 2. The required elasticity is obtained by winding several strips around themselves and amongst themselves, typically 2 strips, 1 cm wide cut from the meltblown nonwoven material 1.

### Example 6: Assembly of the Mask From the Elements Produced in Examples 1 to 5

A mask is produced using the elements obtained in examples 1 to 5 with the following structure: spunbond 1 - Espun membrane 1 - spunbond 3. The “spunbond 1” nonwoven (41 g/m²) forms the outer layer and improves the mechanical strength of the mask body. The “Espun 1” intermediate layer provides for aerosol filtration. Lastly, the “spunbond 3” nonwoven (21.7 g/m²) placed inside the mask is intended to be in contact with the face of the user, offering great use comfort, and it also protects the filtration layer from possible degradation.

The assembly follows the steps described below:
Cohesion between the layers of nonwovens is obtained by lamination.
The nose bridge produced in example 4 is inserted into a space created by folding the nonwoven material over a width of 5 ± 2 mm close to the periphery of the mask. The bridge is retained by spot welds placed regularly along the length of the fold.
The elastic bands produced in example 5 are fixed on each side of the mask so as to form a loop and are fixed without addition of material by ultrasonic welding.

### Example 7: Grinding/Granulation and Characterization of the Recycled Material

After decontamination by passing through an oven at 70° C. for one hour, the masks are ground in a knife mill. The flakes obtained are fed into a BUSS-type twin-screw extruder at 230° C. in order to produce granules.

The quality of the recycled product PVDF-R1 thus obtained is verified by thermal analysis and viscosity measurement. The characteristics then obtained, presented in table 5, are similar to those of the largely predominant material used in the production of the spunbond nonwoven.

TABLE 5

PVDF-R1

| | |
|---|---|
| Melting temperature (°C) | 168.5 |
| Melt viscosity at 230° C., 100 s⁻¹ (Pa.s) | 315 |
| Melt flow rate at 2.16 kg, 230° C. (g/10 min) | 33 |

1. A respiratory protection mask made from polyvinylidene fluoride and having the following structure:
an inner layer of nonwoven PVDF,
a central PVDF layer composed of a support layer made from PVDF and an electrospun layer of PVDF nanofibers,
an outer layer of nonwoven PVDF,
a PVDF nose bridge, and
PVDF retaining straps.

2. The mask as claimed in claim 1, wherein said inner layer is a nonwoven PVDF and has a grammage of between 20 and 100 g/m².

3. The mask as claimed in claim 1, wherein said support layer is a nonwoven PVDF and has a grammage of between 20 and 100 g/m².

4. The mask as claimed in claim 1, wherein said support layer is a PVDF produced by extrusion spinning.

5. The mask as claimed in claim 1, wherein said electrospun layer of PVDF nanofibers comprises at least one of: a PVDF homopolymer; a mixture of two PVDF homopolymers; a copolymer comprising vinylidene difluoride (VDF) units and one or more types of units of comonomers compatible with vinylidene difluoride; a mixture of a PVDF homopolymer and of a VDF copolymer; or a mixture of two VDF copolymers.

6. The mask as claimed in claim 5, wherein said comonomer compatible with VDF is selected from the group consisting of: vinyl fluoride, tetrafluoroethylene, hexafluoropropylene, trifluoropropenes, tetrafluoropropenes, hexafluoroisobutylene, perfluorobutylethylene, pentafluoropropenes, perfluoroalkyl vinyl ethers of the general formula Rf-O-CF-CF2, Rf being an alkyl group, bromotrifluoroethylene, chlorofluoroethylene, chlorotrifluoroethylene and chlorotrifluoropropene.

7. The mask as claimed in claim 1, wherein the mean thickness of the layer of PVDF nanofibers is from 0.1 µm to 100 µm.

8. The mask as claimed in claim 1, wherein, when said layer of nanofibers is composed of a mixture of two constituents, the proportion by mass between them ranges from 1:99 to 99:1.

9. The mask as claimed in claim 1, wherein said PVDF nanofibers have a mean fiber diameter Dv50 of between 30 and 500 nm.

10. The mask as claimed in claim 1, wherein said outer layer of nonwoven PVDF has a grammage of between 10 and 60 g/m².

11. The mask as claimed in claim 1, wherein said retaining straps are adjustable loops produced by injection molding or 3D printing or elastic bands based on PVDF textile.

12. A method for manufacturing the mask as claimed in claim 1, said method comprising the following steps:
providing a first layer of nonwoven PVDF, intended to constitute the outer and inner layers;
providing a second layer of PVDF, the latter being chosen from nonwoven polymer or polymer obtained by extrusion spinning, intended to constitute the support layer of the central layer;
depositing on said support layer, via an electrospinning process, a layer of PVDF nanofibers;
inserting a nose bridge composed of a mixture of PVDF homopolymer and of a VDF copolymer, and
welding, PVDF retaining straps onto the body of the mask, at the ends.

13. A method for reconditioning the mask as claimed in claim 1, said method implementing a technique chosen from:
treatment with a solution of hydrogen peroxide at a concentration of less than 8%;
treatment with UV-C with an energy of greater than or equal to 1 J/cm²; or
treatment with dry or wet heat at a temperature of greater than or equal to 60° C.

14. A method for recycling used PVDF respiratory protection masks, said masks having the structure as claimed in claim 1, said method comprising the following steps:
grinding the masks to result in the obtaining of flakes,
granulating said flakes to result in the obtaining of PVDF granules, and
using said granules for the transformation of the PVDF via a molten or solvent-based route.
